(19) United States
(12) Patent Application Publication
(10) Pub. No.: US 2026/0319495 A1
(43) Pub. Date: Oct. 15, 2026

(54) VEHICLE POSITION ESTIMATION METHOD, DRIVING CONTROL METHOD, A NON-TRANSITORY COMPUTER-READABLE RECORDING MEDIUM, VEHICLE POSITION ESTIMATION DEVICE, AND MOVING BODY

(71) Applicant: MoveEz, Inc., Ishikawa (JP)

(72) Inventors: Kouta JINBO, Ishikawa (JP); Keisuke Yoneda, Ishikawa (JP); Ryou Yanase, Ishikawa (JP)

(21) Appl. No.: 19/643,280

(22) Filed: Apr. 9, 2026

(30) Foreign Application Priority Data
Apr. 10, 2025 (JP) 2025-065013

(51) Int. Cl. G05D 1/243; G05D 111/10; G06V 10/774; G06V 10/82; G06V 20/56

(52) U.S. Cl. CPC G05D 1/243; G06V 10/774; G06V 10/82; G06V 20/588; G05D 2111/17

(57) ABSTRACT

The vehicle position estimation method includes: a first learning step in which a convolutional neural network is trained using, as input data, a training observation image including road-surface information and a training map image including a map of a region corresponding to the training observation image; a second learning step in which the convolutional neural network is trained using, as input data, a processed image obtained by processing the training observation image together with the training map image; an observation-image acquisition step for acquiring an observation image including road-surface information; a map-image acquisition step for acquiring a map image; and an estimation step for estimating the position of the host vehicle using the observation image and the map image together with the trained convolutional neural network.

### TECHNICAL FIELD

The present invention relates to a vehicle position estimation method, a driving control method, a program, a vehicle position estimation device, and a moving body.

### BACKGROUND TECHNOLOGY

Currently, research on autonomous driving of mobile vehicles such as automobiles is actively underway (see patent document 1, etc.). In the autonomous driving, it is necessary to estimate the position of the moving body. For example, patent document 1 describes a technology for estimating the position of one's own vehicle based on observation images acquired by the imaging device. Patent Document 1 discloses a technique that estimates the vehicle position based on a captured observation image and evaluates the reliability of the estimate by detecting lane markings in both the observation image and a corresponding map image and then calculating their degree of matching. In doing so, the technique of Patent Document 1 attempts to avoid position estimation based on observation images of low reliability.

### PRIOR ART DOCUMENTS

### Patent Documents

[Patent Document 1 ] Special Bulletin No. 2020-26985

### SUMMARY OF THE INVENTION

### Problems to be Solved by the Invention

In the invention described in Patent Document 1, lane markings must be detected from the acquired observation image and the map image. However, for example under rainy conditions, lane markings may fail to be detected.

Accordingly, an object of the present invention is to provide, inter alia, a vehicle position estimation method that can accurately estimate the position of an ego-vehicle even when road-surface information contained in the observation image changes depending on weather or other conditions.

### Means for Solving the Problems

To achieve the above object, a vehicle position estimation method according to one aspect of the present invention uses a machine learning (ML) model, such as a convolutional neural network (CNN), to estimate the position of an ego-vehicle and is executed by a computer. The method may include: a first learning step of training the ML model using, as input data supplied to the ML model, a training observation image including road-surface information and a training map image including a map of a region corresponding to the training observation image; a second learning step of training the ML model using, as input data, a processed image obtained by processing the training observation image and the training map image; an observation-image acquisition step of acquiring an observation image including the road-surface information around the ego-vehicle; a map-image acquisition step of acquiring a map image including a map of a region corresponding to the observation image; and an estimation step of estimating the position of the ego-vehicle using the observation image, the map image, and the ML model trained by the first and second learning steps; wherein, in the processed image, the road-surface information included in the training observation image has been processed.

To achieve the above object, a driving control method according to one aspect of the present invention includes the above vehicle position estimation method and a driving control step of performing driving control of the ego-vehicle based on the position of the ego-vehicle estimated by the vehicle position estimation method.

To achieve the above object, a program according to one aspect of the present invention is a program for causing a computer to execute the above vehicle position estimation method.

To achieve the above object, a vehicle position estimation device according to one aspect of the present invention is a device that estimates the position of an ego-vehicle using a convolutional neural network, and includes: an observation-image acquisition unit that acquires an observation image including information on the road surface around the ego-vehicle; a map-image acquisition unit that acquires a map image including a map of a region corresponding to the observation image; and an estimation unit that estimates the position of the ego-vehicle using the observation image, the map image, and a trained convolutional neural network. The convolutional neural network has been trained using, as teacher data for input data supplied to the convolutional neural network, a training observation image including road-surface information and a training map image including a map of a region corresponding to the training observation image, and further has been trained using, as teacher data for the input data, a processed image obtained by processing the training observation image and the training map image, wherein in the processed image, the road-surface information contained in the training observation image has been processed.

To achieve the above object, a mobile object according to one aspect of the present invention includes the above vehicle position estimation device and a driving control unit that controls travel of the ego-vehicle based on the position of the ego-vehicle estimated by the vehicle position estimation device.

These comprehensive or specific aspects may be realized in recording media such as systems, methods, integrated circuits, computer programs, or non-transient computer-readable CD-ROMs, or by any combination of systems, methods, integrated circuits, computer programs, and recording media.

### Effect of Invention

According to the present invention, even when the road-surface information included in an observation image varies depending on weather or the like, it is possible to provide a vehicle position estimation method and the like that can accurately estimate the position of the ego-vehicle.

### BRIEF DESCRIPTION OF THE DRAWINGS

FIG. 1 is a block diagram showing an example configuration of a vehicle position estimation device and a mobile object according to an embodiment.

FIG. 2 is a diagram showing an example of an observation image acquired by the observation-image acquisition unit according to the embodiment.

FIG. 3 is a diagram showing an example of a map image acquired by the map-image acquisition unit according to the embodiment.

FIG. 4 is a diagram showing the configuration of the convolutional neural network used by the estimation unit according to the embodiment.

FIG. 5 is a diagram showing an example of prediction data according to the embodiment. FIG. 6 is a diagram showing an example of a training observation image according to the embodiment.

FIG. 7 is a diagram showing an example of a processed image according to the embodiment.

FIG. 8 is a diagram showing an example of teacher data for output data of the convolutional neural network according to the embodiment.

FIG. 9 is a diagram showing an inclination angle of an image of a lane marking included in a training observation image.

FIG. 10 is a diagram showing a training observation image to which a noise region extending parallel to the x-axis direction has been added.

FIG. 11 is a diagram showing a processed image including a noise region extending along an image of a lane marking.

FIG. 12 is a diagram showing another example of a processed image according to the embodiment.

FIG. 13 is a flowchart showing the procedure of the vehicle position estimation method according to the embodiment.

FIG. 14 is a graph showing similarities of correlation distributions in clear weather and rainy weather, estimated using the vehicle position estimation method and device according to the embodiment.

FIG. 15 is a diagram showing an example of a correlation distribution serving as correct data for output data of the convolutional neural network according to the embodiment.

FIG. 16 is a diagram showing an example of a correlation distribution that is prediction data when the convolutional neural network according to the embodiment does not have a skip-connection mechanism.

FIG. 17 is a diagram showing an example of a correlation distribution that is prediction data when the convolutional neural network according to the embodiment has a skip-connection mechanism.

FIG. 18 is a diagram showing an example of a correlation distribution serving as correct data for output data of the convolutional neural network according to the embodiment.

FIG. 19 is a diagram showing a correlation distribution that is prediction data in a loss function used for training the convolutional neural network according to the embodiment when weighting based on correlation values of the correlation distribution is not performed.

FIG. 20 is a diagram showing a correlation distribution that is prediction data in a loss function used for training the convolutional neural network according to the embodiment when weighting based on correlation values of the correlation distribution is performed.

### Form for Implementing Invention

Hereinafter, embodiments of the present invention will be described in detail with reference to the drawings.

It should be noted that the embodiments described below each present comprehensive or specific examples. Numerical values, shapes, materials, components, positions and connection forms of components, steps, the order of steps, and the like shown in the following embodiments are merely examples and are not intended to limit the present invention. Further, among the components in the following embodiments, components that are not recited in the independent claims indicating the highest-level concept are described as optional components.

The drawings are schematic and are not necessarily depicted to strict scale. In the drawings, the same reference numerals denote the same constituent elements.

### Configuration of Vehicle Position Estimation Device and Mobile Object

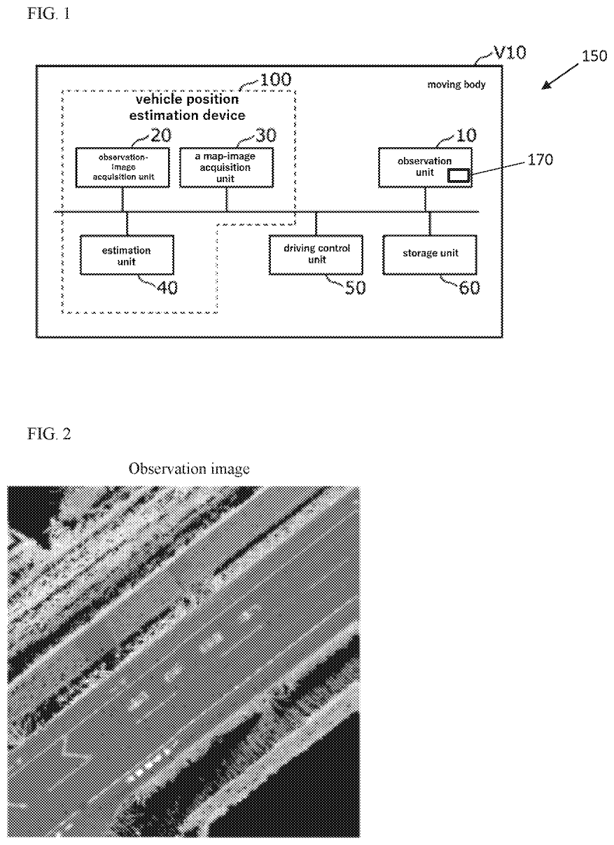

The configuration of the vehicle position estimation device and the mobile object, according to various embodiments, will be explained with reference to FIG. 1.

FIG. 1 is a block diagram illustrating an example configuration of a system 150 that includes a vehicle position estimation system 100 and a mobile object V10. The features of system 150 described below with reference to FIG. 1 are functional features that may be implemented by any combination of one or more hardware components. For example, one or more hardware processors may perform one or more aspects of the functions of the functional features of system 100. Reference to a “unit” below is intended to mean a functional unit-a discrete function performed by the given unit. A unit may be a discrete hardware component and/or may be one or more software programs executed by the same hardware processor or multiple hardware processors.

The mobile object V10 is a moving body including a vehicle position estimation system 100 and a driving control unit 50. The mobile object V10 may include an observation unit 10 and a storage unit 60. The mobile object V10 is not particularly limited as long as it is a mobile object that can be controlled at least partially by the driving control unit 50. For example, the mobile object V10 may be a vehicle that performs autonomous driving.

The observation unit 10 observes the surroundings of the ego-vehicle. The “ego-vehicle” is the vehicle whose position is estimated by the vehicle position estimation system 100. In the illustrated example, the ego-vehicle is the mobile object V10. Hereinafter, the mobile object V10 is also referred to as the ego-vehicle.

The observation unit 10, by observing the surroundings of the ego-vehicle, generates an observation image that includes information on the road surface around the ego-vehicle. Here, “road-surface information” is information regarding the road surface obtained by observation and may include any information concerning the road surface. The road-surface information includes, for example, an image of road markings. Road markings are indicia provided on the road surface-such as lane markings, letters, and symbols-for organizing, guiding, and regulating traffic. Lane markings are linear indicia provided on the road surface, such as white or yellow lines. Road markings may be formed, for example, by painting. The road-surface information is not limited to images of road markings. The road-surface information may include, for example, images of structures installed on the road surface, such as curbs or poles provided on a median strip. The road-surface information may also include, for example, images of puddles, ruts, recesses, protrusions, and the like formed on the road surface.

The observation unit 10 is a sensor system that generates three-dimensional point cloud data including distance information from a reference point to distance-measurement targets located around the reference point. The reference point may be included in the mobile object V10. That is, the reference point may be located on the mobile object V10 and can move together with the mobile object V10. More specifically, the reference point corresponds to a measurement reference point, which may be the position of at least one sensor of the observation unit 10 included in the mobile object V10. Distance-measurement targets include roads, sidewalks, buildings, and mobile objects located around the reference point. Mobile objects include, for example, vehicles such as automobiles and motorcycles, and pedestrians. Mobile objects located around the reference point may include other objects capable of moving.

The observation unit 10 may sequentially generate each of a plurality of observation images. Using the measurement reference point as the reference point, the observation unit 10 measures, as distance information, three-dimensional information including the azimuth (horizontal direction) in which surrounding distance-measurement targets are located, the distance to the surface of the distance-measurement target, and the height. As the observation unit 10, for example, LiDAR (Light Detection and Ranging) or the like can be used. In some embodiments, the observation unit 10 includes a LiDAR system. The observation unit 10 may further include a system for estimating the position and attitude angle of the mobile object V10. For example, the observation unit 10 may include a GNSS/INS (Global Navigation Satellite System/Inertial Navigation System) integrated navigation system 170.

The LiDAR system irradiates a target object with laser light and acquires laser light reflected from the object to measure the distance between the object and the measurement reference point included in the LiDAR system. From the measured distance, the position of the LiDAR system, and the irradiation direction of the laser light, the observation unit 10 acquires three-dimensional point cloud data indicating the relationship between the horizontal position and height of objects around the measurement reference point.

For example, a LiDAR system may emit 128 laser beams in mutually different irradiation angles in the vertical direction (i.e., the gravity direction). The vertical field of view of the LiDAR system may be, with the horizontal direction (i.e., the direction perpendicular to the vertical direction) taken as 0 degrees (0 degree), for example,−25 degrees or more and 15 degrees or less. By rotating the irradiation directions of these laser beams 360 degrees in the horizontal direction, the LiDAR system can acquire omnidirectional three-dimensional point cloud data. The scan rate of the laser beams may be any suitable rate, such as, for example, 2 Hz or more and 20 Hz or less. The scan rate can be, for example, set to 10 Hz. That is, the LiDAR system may acquire ten frames of three-dimensional point cloud data per second.

The vehicle position estimation system 100 estimates the position of the ego-vehicle using a machine learning model, such as a convolutional neural network or a vision transformer. As shown in FIG. 1, the vehicle position estimation system 100 may include an observation-image acquisition unit 20, a map-image acquisition unit 30, and an estimation unit 40. The vehicle position estimation system 100 may also include the observation unit 10.

The observation-image acquisition unit 20 is a processing unit that acquires an observation image including information on the road surface around the ego-vehicle. The observation-image acquisition unit 20 may acquire position information of objects around the ego-vehicle. Objects whose position information is acquired by the observation-image acquisition unit 20 may include mobile objects and stationary objects around the ego-vehicle. For example, mobile objects include vehicles and pedestrians, and stationary objects include stopped vehicles, buildings, traffic signs, and the like. The observation image acquired by the observation-image acquisition unit 20 according to various embodiments will be described with reference to FIG. 2. FIG. 2 is a diagram illustrating an example of an observation image acquired by the observation-image acquisition unit 20. As shown in FIG. 2, the observation image according to the illustrated embodiment is a two-dimensional image generated based on three-dimensional point cloud data. The observation image may be a two-dimensional image that looks down at the road surface observed by the observation unit 10 from directly above (i.e., downward in the vertical direction). The observation image may be created by integrating road-surface information observed by the observation unit 10 at one or more time points, such as at least one time point, at least two time points, at least three time points, etc. The information at a given point on the road surface at a second time point is associated and integrated with the corresponding point on the road surface at the first time point according to the amount of movement of the mobile object V10 from the second time point to the first time point (e.g., estimated using the GNSS/INS integrated navigation system 170). The size of the observation image may be set as appropriate. For example, among the images integrated in the manner described above, an image including pixels of 256 [pix] × 256 [pix] around the mobile object V10 may be clipped and used as the observation image.

The observation-image acquisition unit 20 may acquire the observation image from the observation unit 10. The observation image includes, for example, information such as (e.g., pixels associated with) road markings on the roadway, positions of lateral edges of the roadway, and/or positions of shoulders.

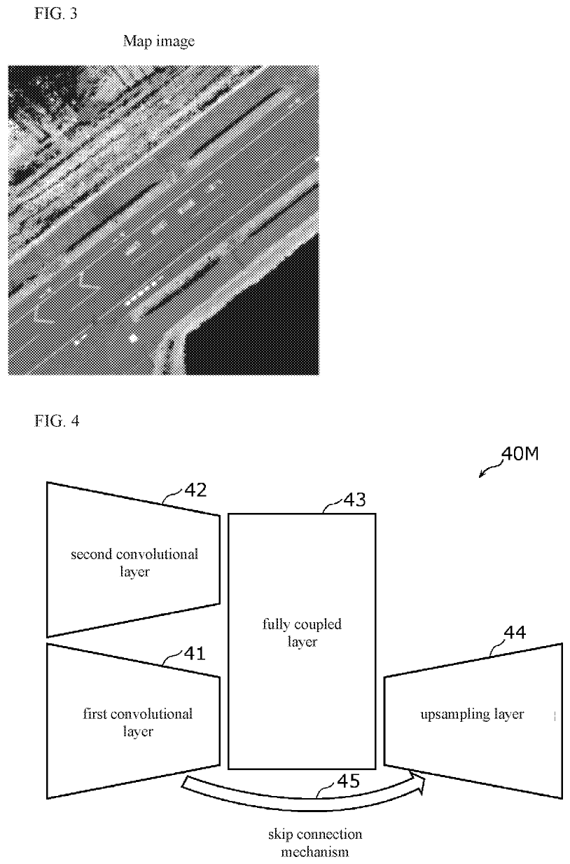

The map image acquisition unit 30 shown in FIG. 1 may acquire one or more map images that includes a map of an area corresponding to the observation image acquired by the observation image acquisition unit 20. A map image containing a map of the area corresponding to the observation image is a map image that represents the area corresponding to at least part of the area indicated by the observation image. Here, map images are not particularly limited to images corresponding to road surfaces. Map images may be stored in advance, for example, in memory section 60. FIG. 3 is an example of a map image that may be acquired by a map image acquisition unit 30. For example, as shown in FIG. 3, the map image may be an image looking down from the top on the road surface where the mobile V10 is located. An exemplary map image may include 320 [pix] × 320 [pix] pixels. The method of generating map images is not particularly limited. Map images may be created by projecting 3D point cloud data collected in advance by LiDAR onto a 2D plane from a perspective looking down onto the 2D plane. As such, a “map” image, as used herein, can refer to an image depicting a region from above. Observation images may be generated similarly to map images-i.e., by projecting 3D point cloud data onto a 2D plane from above). The map image may be generated based on sensor data gathered, for example, by a mapping vehicle traveling along roads and the like where vehicle position estimation may be performed. For example, a mapping vehicle configured with a one or more of the features described herein may traverse roads of a region and collect data (e.g., LiDAR data) for generating one or more map images. The collected data may be used to generate one or more map images of the region. The one or more map images may be generated by the mapping vehicle as it traverses the region or may be generated by a separate computing system that receives the collected data from the vehicle. For example, the mapping vehicle may upload the collected data to a server via one or more wired and/or wireless communication links, and the server may include one or more software programs for generating one or more map images based on the collected data. Optionally, map images may be generated from data collected by multiple mapping vehicles. One or more map images may be updated over time based on newly collected data to account for changes over time in stationary objects in the region.

The map image acquisition unit 30 may acquire from the memory unit 60, a map image corresponding to the observation image acquired by the observation image acquisition unit 20, for example, based on the position information of the moving object V10 measured by the observation unit 10. For example, the map image acquisition unit 30 may acquire a particular map image based on the map image having the GNSS coordinates of the current position of the mobile body V10. The map image acquisition section 30 may acquire the map image by any other suitable methods. For example, system 100 may use wireless communication to acquire map images from a system remote to the mobile V10.

The estimation unit 40 shown in FIG. 1 estimates the position of the vehicle using observation images and map images and a trained machine learning model. The estimation unit 40 may use Dead Reckoning (DR) to estimate the position of the mobile V10 from the value of integrating the velocity of the mobile V10. Estimation unit 40 corrects the error of the estimation by DR by performing map matching, in which a map image acquired based on the GNSS/INS combined navigation system 170 and the observation image are compared using a machine learning model. As a result, the estimation unit 40 performs vehicle position estimation (in other words, self-position estimation).

The machine learning model used in the estimation unit 40 can be a convolutional neural network in which observation images and map images are input and information related to the correlation between the observation image and the map image is output. For example, the output data of the convolutional neural network may be a correlation distribution.

The machine learning model was trained (e.g., trained offline) using training data that includes learning observation images containing road surface information and learning map images containing a map of the area corresponding to the learning observation images. The training data can include a processed image that is derived from a learning observation image. As used herein, the term “processed image” means an observation image that has been artificially modified to include alteration to information associated with roads. The artificial modification can degrade the road information in a manner that simulates the affect that conditions such as rain or snow may have on observation images. The processed image may be generated from an observation image by processing the road surface information contained in the observation image, such as by adding noise or other modification(s) to the road surface information. As such, the processed image can be considered an artificially degraded observation image. Optionally, the training data used to train the machine learning model includes one or more observation images captured during suboptimal conditions, such as while rain or snow was falling.

In at least some embodiments, some or all of the learning map images and some or all of the learning observation images are generated from the same point cloud data. For example, a map learning image can be a map image generated from point cloud data and a corresponding learning observation image can be an observation image generated from the same point cloud data and then modified to degrade the road information. In at least some embodiments, the learning map images and the learning observation images are generated from point cloud data gathered on different days. the learning map images may be generated only from point cloud data gathered under clear weather conditions.

The convolutional neural network uses an observation image for learning and a map image for learning including a map of the area corresponding to the observation image for learning as input data, and, as the training data of the output data, the correlation distribution between the observation image for learning and the map image for learning has been used to train it. In addition, the convolutional neural network is, processed images and map images for learning, and as the training data of the output data, the correlation distribution between the observation images for learning and the map images for learning has been used to train.

Here, the above correlation distributions are the same data. In other words, when the observation image for learning is used as input data, the training data of the output data is the same as the training data of the output data when the processed image processed by the observation image for learning is used as the input data.

The observation image for learning includes the image of the road surface marking as the information of the road surface, and in the processed image, at least part of the image of the road surface marking is artificially degraded, for example, via deletion or addition of noise.

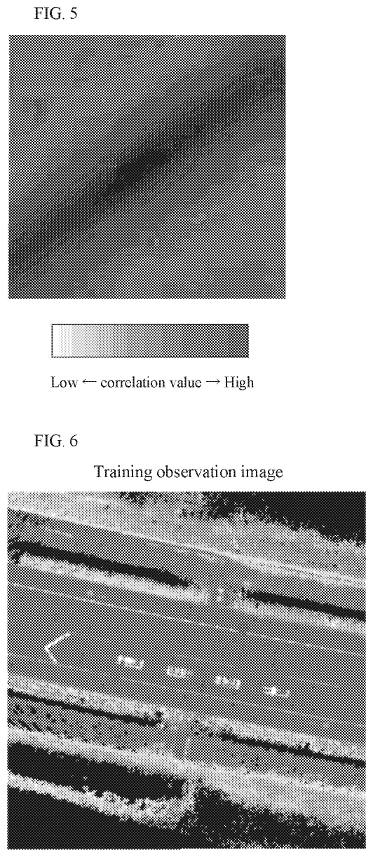

The convolutional neural network used by the estimation unit 40 is described using FIG. 4. FIG. 4 is a diagram showing the configuration of an exemplary convolutional neural network 40M that may be used by the estimation unit 40. As shown in FIG. 4, the convolutional neural network 40M has a first convolutional layer 41, a second convolutional layer 42, a fully coupled layer 43, and an upsampling layer 44. In the illustrated example, the convolutional neural network 40M additionally has a skip connection mechanism 45.

The first convolutional layer 41 is an encoder that inputs the observation image and convolutes the observation image. The first convolutional layer 41 may have a structure in which multiple convolutional layers are stacked. More specifically, in the first convolutional layer 41, the size of the feature map corresponding to the observation image may be reduced by pooling after one or more (e.g., two) repetitions of convolution, BN (Batch Normalization), and ReLU. This allows the first convolutional layer 41 to abstract the observed image. In at least some examples, the first convolutional layer 41 extracts the features of the images such as road surface markings and curbs contained in the observation images.

The second convolutional layer 42 is an encoder in which a map image is input and the map image is convoluted. The second convolutional layer 42 may have a structure in which multiple convolutional layers are stacked. More specifically, in the second convolutional layer 42, as in the first convolutional layer 41, the size of the feature map corresponding to the map image may be reduced by pooling after one or more (e.g., two) repetitions of convolution, BN, and ReLU. This allows the second convolutional layer 42 to abstract the map image. In other words, in the second convolutional layer 42, the features of the image such as road surface markings and curbs contained in the map image are extracted.

The fully connected layer 43 is a layer that combines all variables output from the first convolutional layer 41 and the second convolutional layer 42.

The skip-connection mechanism 45 is a mechanism that transmits features obtained in the first convolutional layer 41 to the upsampling layer 44 without passing through the fully connected layer 43. The features transmitted by the skip-connection mechanism 45 may be features output from a convolutional layer located before the convolutional layer that outputs data to the fully connected layer 43 among the plurality of convolutional layers in the first convolutional layer 41. In this way, features output from a convolutional layer closer to the input within the first convolutional layer 41 may be transmitted to the upsampling layer 44.

The upsampling layer 44 is a decoder that receives the variables output from the fully connected layer 43 and performs upsampling. In this embodiment, features from the first convolutional layer 41 are input to the upsampling layer 44 via the skip-connection mechanism 45. In the upsampling layer 44, the features obtained by upsampling and the features input via the skip-connection mechanism 45 are concatenated in the channel direction and convolved. This restores the feature maps.

In this embodiment, the upsampling layer 44 outputs, as output data, prediction data of a correlation distribution between the observation image and the map image. An example of prediction data output by the upsampling layer 44 will be described with reference to FIG. 5. FIG. 5 shows an example of prediction data according to this embodiment. The prediction data shown in FIG. 5 indicates a two-dimensional distribution of correlation values between the observation image and the map image. These correlation values correspond to the probability of the presence of the mobile object V10 in the map image. As shown in FIG. 5, the correlation values become higher along the road region of the map image.

The driving control unit 50 shown in FIG. 1 is a processing unit that controls travel of the ego-vehicle. The driving control unit 50 may control travel based on the position of the ego-vehicle estimated by the estimation unit 40. For example, the driving control unit 50 controls the traveling direction of the ego-vehicle based on the position of the ego-vehicle and map information stored in the moving

The storage unit 60 stores information for estimating the position of the ego-vehicle. For example, the storage unit 60 stores map images acquired by the map-image acquisition unit 30, map information including information on roads on which the ego-vehicle travels, such as stationary structural landmarks such as road edges, lane boundaries, guardrails, telegraph poles, and buildings, and the like. The storage unit 60 may also store information for autonomous driving, such as route data, intersection geometry, traffic regulations (e.g., speed limits, stop lines), and drivable-area information for decision-making.

### Teacher Data

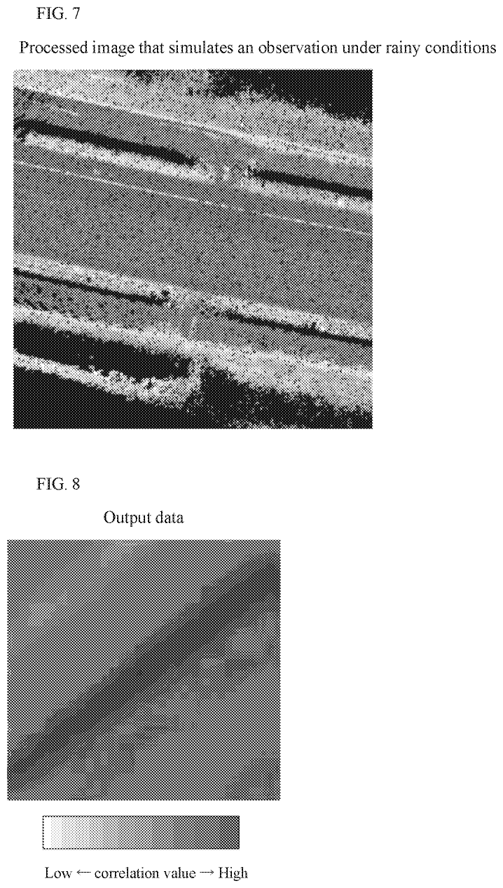

Teacher data (often referred to as labels) used in training the convolutional neural network 40M employed by the estimation unit 40 of the vehicle position estimation system 100 will be described with reference to FIGS. 6 to 8. FIG. 6 shows an example of a training observation image. FIG. 7 shows an example of a processed image. FIG. 8 shows an example of teacher data for output data of the convolutional neural network 40M.

In the example shown in FIG. 6, the training observation image is generated, similarly to the observation image described above, based on three-dimensional point cloud data acquired by LiDAR or the like. The training observation image includes information on the road surface on which a mobile object, such as a vehicle gathering training data (which may be configured the same as, or similar to, the mobile object V10), travels. For example, the training observation image is generated using three-dimensional point cloud data acquired by LiDAR in clear weather.

The processed image shown in FIG. 7 is an image obtained by processing the road-surface information in the training observation image shown in FIG. 6. The processed image shown in FIG. 7 simulates an observation image in rainy weather. In rainy weather, rainwater may accumulate on the road surface, making road markings unobservable. In the processed image shown in FIG. 7, simulating an observation image in rainy weather, a portion of the image of the road markings included in the training observation image is deleted. More specifically, in the processed image, noise is added to the road-surface information so that a portion of the image of the road markings is deleted. A method for generating such a processed image will be described later.

The teacher data for the output data shown in FIG. 8 corresponds to a correlation distribution between the training observation image and the training map image. The teacher data for the output data is, for example, a correlation distribution obtained by template matching between the training observation image and the training map image. In template matching, for example, zero-mean normalized cross-correlation (ZNCC) may be used. Other examples of similarity metrics that may be used include cosine similarity and functions trained using deep neural networks (DNNs). However, any suitable similarity metric may be used.

The teacher data for the output data shown in FIG. 8 is used as teacher data when the training observation image shown in FIG. 6 is used as teacher data for the observation image, and is also used as teacher data when the processed image shown in FIG. 7 is used as teacher data for the observation image. Thus, the same teacher data for the output data is used whether the training observation image is used as input data or a processed image obtained by processing the training observation image is used as input data.

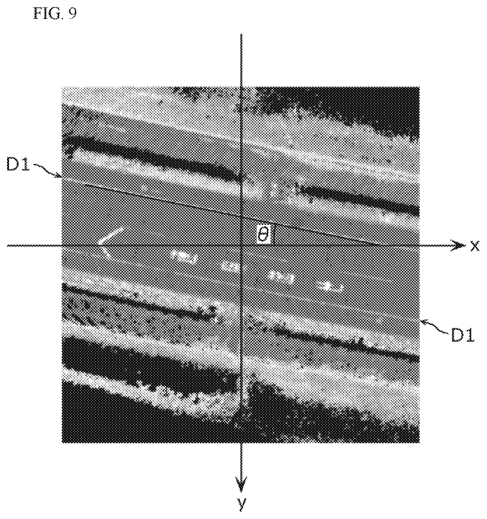

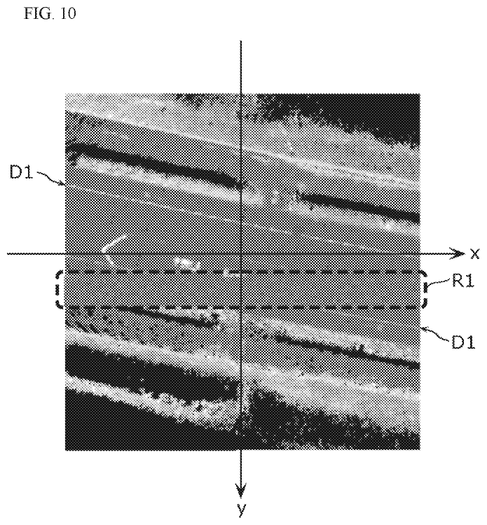

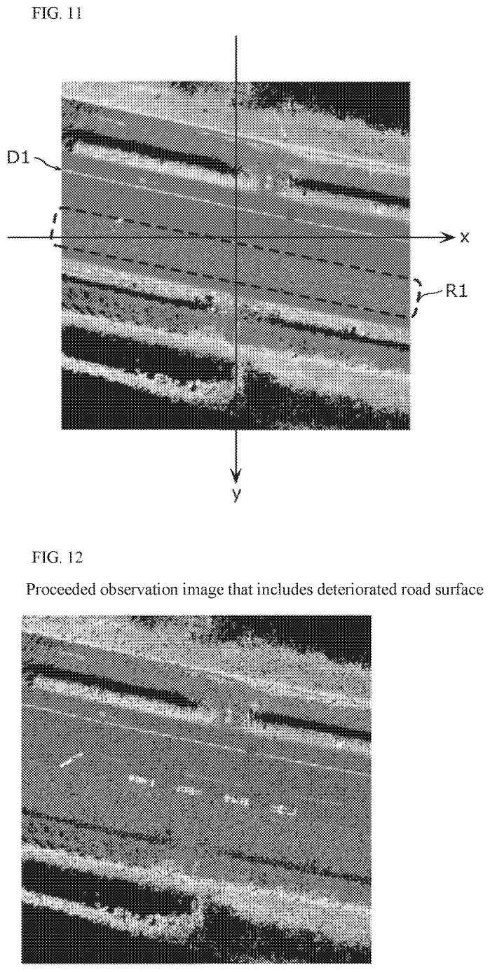

Next, a method for generating a processed image in which a part of the lane markings included in the training observation image is deleted, as in the processed image shown in FIG. 7, will be described with reference to FIGS. 9 to 11. FIG. 9 shows an inclination angle 0 of an image of a lane marking D1 included in the training observation image. FIG. 10 shows a training observation image to which a noise region R1 extending parallel to the x-axis direction is added. Here, a “noise region” is a region to which noise is applied. FIG. 11 shows a processed image including a noise region R1 extending along the image of the lane marking D1. In FIGS. 9 to 11, mutually orthogonal x- and y-axes are shown.

In generating the processed image shown in FIG. 7, first, the training observation image shown in FIG. 9 is prepared. The training observation image shown in FIG. 9 includes, as road-surface information, an image of road markings. The image of the road markings includes an image of the lane marking D1.

Next, the inclination angle 0 of the image of the lane marking D1 included in the training observation image is calculated. Specifically, the straight-line image of the lane marking D1 is detected by performing a Hough transform on the training observation image. In this embodiment, the horizontal direction (i.e., the left-right direction) of the training observation image is defined as the x-axis direction, and the vertical direction is defined as the y-axis direction, and the inclination angle 0 of the image of the lane marking D1 with respect to the x-axis direction is detected. If multiple lane markings are detected by the Hough transform, the average of the inclination angles of the plurality of lane markings may be detected as the inclination angle 0. By extending the Hough transform, the image of a lane marking can be detected even when the training observation image includes a curved lane marking image.

Next, as shown in FIG. 10, a noise region R1 extending in the x-axis direction is generated. In this embodiment, the noise region R1 is a region that simulates a region of the road-surface image in the training observation image other than the image of the road markings. For example, the noise region R1 may be an image region simulating asphalt. The width of the noise region R1 (the dimension in the y-axis direction in FIG. 10) is, for example, at least as large as the width of a lane marking. The width of the noise region R1 may be equal to or less than the width of the road, or equal to or less than the width of one traffic lane of the road.

Next, as shown in FIG. 11, the noise region R1 is tilted by the inclination angle 0. This makes it possible to generate a processed image including the noise region R1 that extends along the image of the lane marking D1. By adjusting the position of the noise region R1 in the y-axis direction, at least a portion of the image of the road markings included in the training observation image is deleted. The adjustment range of the position of the noise region R1 in the y-axis direction may be, for example, within the width of the road (about 3.5 m). The noise region R1 is placed, for example, at a position corresponding to the image of the road included in the training observation image. The position of the noise region R1 in the y-axis direction may be set randomly on the road image included in the training observation image. In this manner, a processed image obtained by processing the training observation image can be generated. Note that the processed image may include a plurality of noise regions R1.

Although FIG. 11 shows an example in which almost the entirety of the image of the road markings is deleted, the processed image is not limited to such an example. Another example of a processed image will be described with reference to FIG. 12. FIG. 12 shows another example of a processed image according to this embodiment. In the processed image shown in FIG. 12, only a part of the image of the road markings is deleted. Thus, by the noise region R1, at least a portion of the image of the lane markings included in the training observation image may be deleted. This makes it possible to generate a processed image that simulates an observation image including degraded (i.e., partially erased) road markings.

In the processed image, noise other than noise that deletes road markings may also be added. For example, in the processed image, noise simulating puddles may be added to the road-surface image included in the training observation image. The puddle-simulating noise may be added at positions corresponding to depressions in the road surface or at positions corresponding to tire tracks. Further, in the processed image, noise simulating ruts formed on the road surface may be added. In this embodiment, processed images simulating situations that occur only rarely and are difficult to observe in practice can be readily generated.

### Vehicle Position Estimation Method

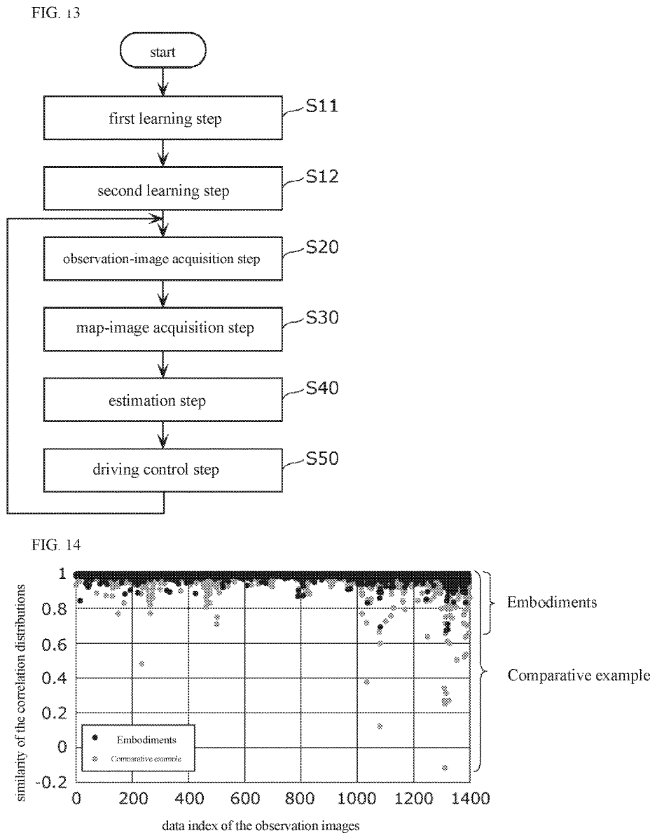

The vehicle position estimation method and the driving control method according to various embodiments will be described with reference to FIG. 13. FIG. 13 is a flowchart showing an exemplary procedure of the vehicle position estimation method. Below, a vehicle position estimation method using the vehicle position estimation system 100 and a driving control method using the mobile object V10, will be described.

The vehicle position estimation method according to this embodiment is a method for estimating the position of the ego-vehicle (i.e., the mobile object V10) using a machine learning model, such as the convolutional neural network 40M, and is executed by a computer. As described above, the convolutional neural network 40M may include the skip-connection mechanism 45.

The vehicle position estimation method may include any combination of: a first learning step S11, a second learning step S12, an observation-image acquisition step S20, a map-image acquisition step S30, and an estimation step S40. The driving control method according to this embodiment includes the respective steps of the vehicle position estimation method and a driving control step S50. Optionally, the first learning step S11 and the second learning step S12 are performed offline, and the observation-image acquisition step S20, map-image acquisition step S30, estimation step S40 are performed one or more times for estimating the position of the ego-vehicle as the ego-vehicle is driving. Steps S11 and S12 may be performed by a different computing system or a different combination of computing systems than one or more of steps S20, S30, and S40. For example, steps S11 and S12 may be performed offline by a computing system of an autonomous driving products and/or services provider that provides autonomous driving capabilities for vehicles. Steps S11 and S12 (and/or one or more other training steps) may provide a trained machine learning model (i.e., an inference model) that may be implemented in the vehicle position estimation system 100 of a given mobile object, such as mobile object V10.

As shown in FIG. 13, first, the machine learning model (e.g., convolutional neural network 40M) may be trained using, as input data to the machine learning model, a training observation image containing road-surface information and a training map image containing a map of a region corresponding to the training observation image (first learning step S11). The teacher data for the output data produced by the convolutional neural network 40M may correspond to a correlation distribution between the training observation image and the training map image.

Next, the convolutional neural network 40M is trained using, as input data to the convolutional neural network 40M, the training map image used in step S11, and a processed image obtained by processing the training observation image (second learning step S12) used in step S11. In the processed image, the road-surface information contained in the training observation image has been processed, such as to degrade a quality of the road-surface information.

The teacher data for the output data produced by the convolutional neural network 40M may correspond to the correlation distribution between the training observation image and the training map image. In addition, the teacher data for the output data in the second learning step S12 is identical to the teacher data for the output data in the first learning step S11. In other words, the teacher data for the output data when the training observation image is used as input data is the same as the teacher data for the output data when a processed image obtained by processing that training observation image is used as input data.

As explained above, the processed image may be generated by adding noise to the road- surface information contained in the training observation image. The training observation image may include, for example, as road-surface information, an image of road markings, and in the processed image, at least part of the image of the road markings may be deleted. This is merely one example of the artificial distortion that can be added in generating the processed image. As noted above, the image of road markings included in the training observation image may include an image of lane markings, and the processed image may include a noise region R1 that extends along the lane-marking image. The noise region R1 may simulate portions of the road-surface image other than the image of the road markings. By means of the noise region R1, at least a portion of the lane-marking image is deleted or otherwise obscured or distorted.

In each of the first learning step S11 and the second learning step S12, a loss function representing the error between the output data of the convolutional neural network 40M and the corresponding teacher data may be used, and weighting may be performed in the loss function based on the correlation values of the correlation distribution serving as the teacher data. This weighting is explained below.

The loss function may be a weighted mean squared error (WMSE). In the first learning step S11 and the second learning step S12, let xᵢⱼdenote the correlation value at row i, column jof the matrix-form correlation distribution that is the output data of the convolutional neural network 40M, tᵢⱼthe teacher-data value, wᵢⱼthe weight, and N the size of the correlation distribution. In this case, the loss function is represented by the following Equation (1).

$$\begin{matrix}[ Equation ( 1 ) ] & \\ WMSE = {\sum }_{i = 1}^{N} {\sum }_{j = 1}^{N} \frac{{{w}_{i j} ( {x}_{i j} - {t}_{i j} )}^{2}}{{N}^{2}} & ( 1 )\end{matrix}$$

In this embodiment, weighting is performed based on the frequency of correlation values in the correlation distribution. Specifically, the correlation values (−1 to 1) are divided into 20 regions, each having a width of 0.1, and the weights are determined based on the number of correlation values of the teacher-data correlation distribution that fall within each region. More specifically, the fewer the correlation values contained in a region, the larger the weight assigned to the correlation values in that region. In other words, the lower the frequency of correlation values in the correlation distribution, the larger the weight. For example, the weight for the correlation values contained in each region may be set inversely proportional to the number of correlation values contained in that region.

Other examples of loss functions that may be used including mean squared error (MSE) and mean absolute error (MAE) for calculating the error between the output distribution and the ground-truth distribution. Other loss function options include distance error between the peak positions of the output distributions.

By performing the first learning step S11 and the second learning step S12 as described above for many sets of teacher data, the trained machine learning model (e.g., convolutional neural network 40M) is prepared. The trained machine learning model may be implemented (e.g., loaded, installed, etc.) in the estimation unit 40 of the vehicle position estimation system 100 of one or more mobile objects, such as one or more mobile objects V10.

The observation-image acquisition unit 20 of the vehicle position estimation system 100 acquires an observation image including road-surface information around the ego-vehicle (observation-image acquisition step S20). Step S20 may occur as a mobile object, such as an autonomous vehicle, is driving along roads.

Subsequently, the map-image acquisition unit 30 of the vehicle position estimation system 100 acquires a map image including a map of a region corresponding to the observation image (map-image acquisition step S30). The map-image acquisition unit 30 may acquire a map image from storage unit 60, which may store one or more map images corresponding to different geographical regions. For example, map-image acquisition unit 30 may use a previously determined vehicle position estimate (or a vehicle position estimate obtained via the GNSS/INS integrated navigation system 170) to identify the map image stored in storage unit 60 that corresponds to a recently known location of the vehicle and obtain the corresponding map image from the storage unit 60. Optionally, the map-image acquisition unit 30 may acquire one or more map images from one or more other sources, such as by controlling download of a map image from a map image repository, such as a repository of a map image service provider that obtains generates map images for various different geographic regions. A vehicle, such as mobile object such as mobile object V10 may have a wireless communication system, such as a WiFi system or satellite communication system, and may download one or more map images from a map image repository. One or more map images may be downloaded as the vehicle is traversing roads or may be downloaded well in advance. One or more map images may be acquired based on a planned route of a vehicle. For example, a vehicle may have a planned destination and one or more planned routes to reach the destination and may acquire one or more map images for the one or more planned routes. Each map image may cover a portion of a given route and, thus, a plurality of map images may be acquired that cover the entire planned route. As noted above, the map images may be stored in a memory of the vehicle, such as storage unit 60.

Subsequently, the estimation unit 40 of the vehicle position estimation system 100 estimates the position of the ego-vehicle using the observation image and the map image together with the convolutional neural network 40M trained by the first learning step S11 and the second learning step S12 (estimation step S40). FIG. 21 illustrates an example of how the observation image and map image may be used to estimate the position of the own vehicle. The observation image 2102 may be smaller in geographic area than the map image 2104 (e.g., the map image 2104 may be twice the size of the observation image). The observation image 2102 and the map image 2104 may be provided as inputs to the trained machine learning model (e.g., the convolutional neural network 40M trained by the first learning step S11 and the second learning step S12). The machine learning model may output a correlation distribution 2106. The position of the own vehicle may be determined based on the location of the correlation distribution 1406 having the highest correlation. The map image(s) may be correlated with real-world position information (e.g., the longitude and latitude for each pixel may be known and embedded in, or otherwise associated with, the map image) such that correlating the observation image with the map image provides the position of the own vehicle.

Subsequently, in the driving control method according to this embodiment, the driving control unit 50 of the mobile object V10 performs driving control of the ego-vehicle based on the position of the ego-vehicle estimated by the vehicle position estimation method according to this embodiment (driving control step S50).

The process then returns to the observation-image acquisition step S20, and the same processing is repeated. The first learning step S11 and the second learning step S12 may be repeated two or more times using different teacher data.

As described above, with the vehicle position estimation method according to this embodiment, the position of the ego-vehicle can be estimated. In addition, with the driving control method according to this embodiment, travel of the mobile object V10 can be controlled in accordance with the estimated position of the ego-vehicle.

### Effects, etc.

The effects of the vehicle position estimation method and the like according to this embodiment are described below.

As described above, the vehicle position estimation method, according to various embodiments, estimates the position of the ego-vehicle using a machine learning model, such as the convolutional neural network 40M. The vehicle position estimation method is executed by one or more computing systems. The vehicle position estimation method includes one or more of: the first learning step S11 of training the convolutional neural network 40M using, as input data to the convolutional neural network 40M, a training observation image containing road-surface information and a training map image including a map of a region corresponding to the training observation image; the second learning step S12 of training the convolutional neural network 40M using, as input data, a processed image obtained by processing the training observation image and the training map image; the observation-image acquisition step S20 of acquiring an observation image including road-surface information around the ego-vehicle; the map-image acquisition step S30 of acquiring a map image including a map of a region corresponding to the observation image; and the estimation step S40 of estimating the position of the ego-vehicle using the observation image and the map image together with the convolutional neural network 40M trained by the first and second learning steps. In the processed image, the road-surface information contained in the training observation image has been processed.

Moreover, the vehicle position estimation system 100 according to various embodiments estimates the position of the ego-vehicle using the machine learning model. The vehicle position estimation system 100 may include an observation-image acquisition unit 20 that acquires an observation image including road-surface information around the ego-vehicle; a map-image acquisition unit 30 that acquires a map image including a map of a region corresponding to the observation image; and an estimation unit 40 that estimates the position of the ego-vehicle using the observation image and the map image together with the trained machine learning model (e.g., convolutional neural network 40M). The machine learning model has been trained (e.g., offline) using, as input data to the convolutional neural network 40M, a training observation image containing road-surface information and a training map image including a map of a region corresponding to the training observation image, and also has been trained using, as input data, a processed image obtained by processing the training observation image and the training map image. In the processed image, the road-surface information contained in the training observation image has been processed.

The above vehicle position estimation method and the effects of the vehicle position estimation system 100 according to various embodiments will be explained in comparison with a comparative example using FIG. 14. FIG. 14 is a graph showing the similarities of correlation distributions in clear weather and rainy weather estimated using the vehicle position estimation method and the vehicle position estimation system 100 according to this embodiment. In FIG. 14, the horizontal axis represents the data index of the observation images, and the vertical axis represents the similarity of the correlation distributions. The similarity values in FIG. 14 were obtained by repeatedly driving on the same road in clear and rainy weather. For comparison, the similarity of the correlation distributions in a comparative example is also shown. In the comparative example, correlation distributions are computed by template matching using zero-mean normalized cross-correlation (ZNCC) for the clear-weather and rainy-weather observation images used to calculate the similarity in FIG. 14, and the similarity between the clear-weather correlation distribution and the rainy-weather correlation distribution is then calculated.

As shown in FIG. 14, in the comparative example, the similarity of the correlation distributions ranges from about −0.1 to 1, whereas in this embodiment the similarity is concentrated in the range of about 0.7 to 1. Thus, according to the vehicle position estimation method and the vehicle position estimation system 100 of this embodiment, for example, a convolutional neural network 40M can be trained using a training observation image corresponding to an observation image in clear weather and a processed image simulating a rainy-weather observation image generated by processing the training observation image, thereby reducing the effect of weather on vehicle-position estimation accuracy. Therefore, even if the road-surface information contained in the observation image changes depending on the weather or the like, the position of the ego-vehicle can be accurately estimated. In this way, highly robust vehicle position estimation can be realized.

In addition, in the processed image according to this embodiment, noise may be added to the road-surface information.

This makes it easy to generate processed images that simulate various road-surface conditions. Therefore, by training the convolutional neural network 40M using such processed images as training data, more robust vehicle position estimation can be readily achieved.

Moreover, in this embodiment, the training observation image includes an image of road markings as road-surface information, and in the processed image at least a portion of the road-marking image may be deleted.

This facilitates the generation of processed images that simulate, for example, rainy-weather observation images and images containing deteriorated road markings. Accordingly, by training the convolutional neural network 40M using such processed images as training data, more robust vehicle position estimation can be readily achieved.

Further, in this embodiment, the road-marking image included in the training observation image includes an image of lane markings, and the processed image includes a noise region R1 that extends along the lane-marking image. The noise region R1 is a region that simulates portions of the road-surface image other than the road-marking image, and by means of the noise region R1 at least a portion of the lane-marking image may be deleted.

By using such a noise region R1, noise can be applied in the processed image to the lane-marking image, which has a large impact on vehicle-position estimation accuracy. Consequently, by training the convolutional neural network 40M using such processed images as training data, more robust vehicle position estimation can be readily achieved.

In this embodiment, the teacher data for the output data in the second learning step of the convolutional neural network 40M may be identical to the teacher data for the output data in the first learning step.

For example, both when training the convolutional neural network 40M with a training observation image corresponding to a clear-weather observation image as input data, and when training with a processed image corresponding to a rainy-weather observation image as input data, the output data corresponding to the clear-weather observation image can be used as teacher data. This makes it possible to implement a convolutional neural network 40M that outputs the same output data when a rainy-weather observation image is input as when a clear-weather observation image is input. Therefore, a convolutional neural network 40M capable of highly robust vehicle position estimation can be realized.

In addition, in this embodiment, the convolutional neural network 40M includes a skip-connection mechanism 45.

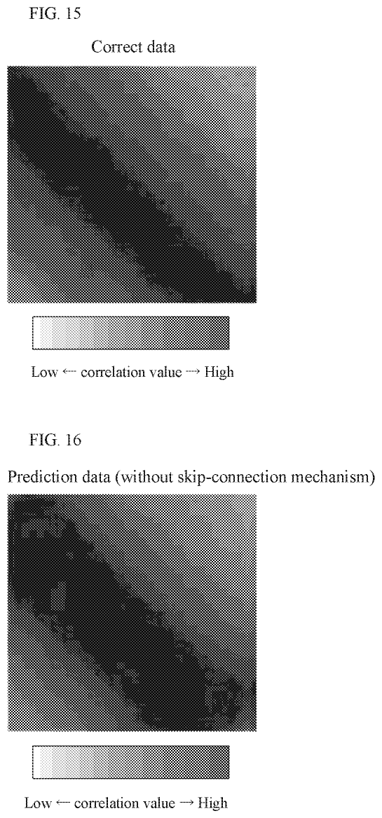

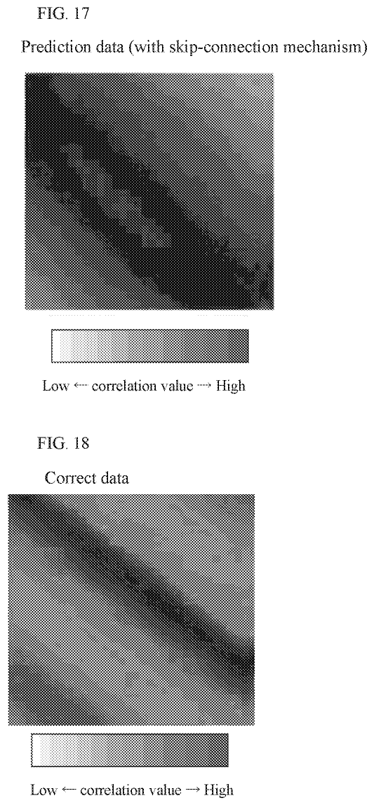

The effect of the skip-connection mechanism 45 will be explained with reference to FIGS. 15 to 17. FIG. 15 shows an example of a correlation distribution serving as correct data (ground truth) for the output data of the convolutional neural network 40M according to this embodiment. FIG. 16 shows an example of a correlation distribution serving as prediction data (output data) when the convolutional neural network 40M does not have the skip-connection mechanism 45. FIG. 17 shows an example of a correlation distribution serving as prediction data when the convolutional neural network 40M has the skip-connection mechanism 45. FIGS. 16 and 17 show output data of the convolutional neural network 40M for the same input data (observation image and map image). FIG. 15 shows the correlation distribution calculated by template matching for the same input data.

When the convolutional neural network 40M includes the skip-connection mechanism 45, the upsampling layer 44 can obtain high-resolution features generated midstream in the first convolutional layer 41. Therefore, as shown in FIG. 17, when the convolutional neural network 40M has the skip-connection mechanism 45, the correlation distribution can be sharper than in the case without the skip-connection mechanism 45 (FIG. 16). In other words, the estimated position of the ego-vehicle can be identified more clearly.

In this embodiment, the teacher data for the output data of the convolutional neural network 40M corresponds to the correlation distribution between the training observation image and the training map image, and in each of the first learning step S11 and the second learning step S12, a loss function representing the error between the output data and the corresponding teacher data is used. Weighting may be performed based on the correlation values of the correlation distribution in the loss function.

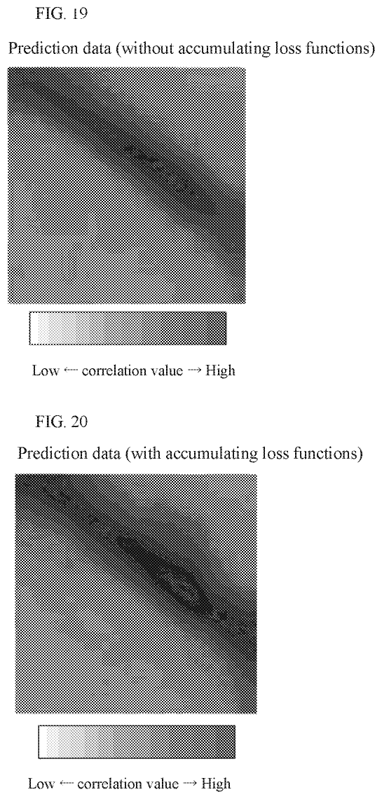

The effect of such weighting will be explained with reference to FIGS. 18 to 20. FIG. 18 shows an example of a correlation distribution serving as correct data (ground truth) for the output data of the convolutional neural network 40M according to this embodiment. FIG. 19 shows a correlation distribution serving as prediction data when, in the loss function used to train the convolutional neural network 40M, no weighting is performed based on the correlation values of the correlation distribution. FIG. 20 shows a correlation distribution serving as prediction data when weighting is performed based on the correlation values of the correlation distribution in the loss function used to train the convolutional neural network 40M. FIGS. 19 and 20 show output data of the convolutional neural network 40M for the same input data (observation image and map image). FIG. 18 shows the correlation distribution calculated by template matching for the same input data.

In a correlation distribution, the region with high correlation values is an important region corresponding to the vehicle position. As shown in FIG. 18, when there are many training samples in which the high-correlation region is small, the estimation of the high-correlation region may lack accuracy. In this embodiment, as expressed by Equation (1), the dependence of estimation accuracy on the distributional trend of the correlation values can be reduced by weighting the correlation values of the correlation distribution in the loss function. For example, in the loss function, weighting is performed based on the frequency of correlation values in the correlation distribution; more specifically, the lower the frequency of occurrence of a correlation value, the higher the assigned weight. This can more reliably reduce the dependence of estimation accuracy on the distribution of correlation values. For example, when few regions with high correlation values exist in the correlation distribution, learning can be performed with emphasis on high-correlation regions. Therefore, the high-correlation region can be estimated accurately.

When weighting is performed based on the frequency of correlation values in the correlation distribution, as shown in FIG. 20, the peak of the correlation values in the predicted correlation distribution can be made closer to the peak of the correlation values in the correct data shown in FIG. 18, compared with the case where no such weighting is performed (FIG. 19). Thus, by weighting based on the frequency of correlation values in the correlation distribution, the region with high correlation values can be estimated accurately.

In this embodiment, the driving control of the ego-vehicle may be carried out based on the vehicle position estimation method or on the vehicle position estimated by the vehicle position estimation system 100.

This enables accurate estimation of the ego-vehicle's position even when the road-surface information contained in the observation image varies with weather or the like, thereby enabling accurate driving control of the ego-vehicle.

### (Modified Examples, etc.)

Although the vehicle position estimation method and the like according to one aspect of the present invention have been described above based on an embodiment, the present invention is not limited thereto. Various modifications conceived by those skilled in the art may be included within the scope of the present invention as long as they do not depart from its purpose.

For example, in the vehicle position estimation method and the vehicle position estimation system 100 of the above embodiment, a map image generated from three-dimensional point cloud data is used; however, any other map image may be used as long as it includes a map of a region corresponding to the observation image.

Further, in the vehicle position estimation method and the vehicle position estimation system 100 of the above embodiment, the convolutional neural network 40M includes the skip-connection mechanism 45, but the convolutional neural network 40M need not necessarily include a skip- connection mechanism 45.

In the embodiment above, the mobile object V10 is presented as an example of the mobile object, but the mobile object is not limited to the mobile object V10. Any object capable of traveling on a road and whose position can be estimated by the vehicle position estimation system 100 may be used.

The following configurations may also be included within the scope of one or more aspects of this disclosure.
(1) Some components of the vehicle position estimation system 100 described above may be implemented by a computer system including a microprocessor, ROM, RAM, a hard-disk unit, and the like, or by a server connected via a network. The RAM or the hard-disk unit stores computer programs, and the microprocessor performs operations according to the programs to implement the functions. Here, a computer program is composed of multiple instruction codes that instruct the computer to perform predetermined functions.
(2) Some components of the vehicle position estimation system 100 described above may be implemented by a single system LSI (large-scale integration). A system LSI is a highly multifunctional LSI fabricated by integrating multiple components on a single chip—specifically, a computer system including a microprocessor, ROM, RAM, and the like. The RAM stores computer programs, and the microprocessor operates in accordance with the programs to implement the functions of the system LSI.
(3) Some components of the vehicle position estimation system 100 described above may be implemented by an IC card or a single module detachable from each device. The IC card or module is a computer system including a microprocessor, ROM, RAM, and the like, and may incorporate the highly multifunctional LSI described above. The IC card or module implements its functions by operating the microprocessor according to a computer program, and may have tamper resistance.
(4) Additionally, some components of the vehicle position estimation system 100 described above may be recorded on recording media from which a computer can read the computer program or a digital signal, such as a flexible disk, hard disk, CD-ROM, MO, DVD, DVD-ROM, DVD-RAM, BD (Blu-ray® Disc), or semiconductor memory. The digital signal may also be recorded on such recording media.

Further, some components of the vehicle position estimation system 100 described above may be provided by transmitting the computer program or the digital signal via a telecommunication line, a wireless or wired communication line, a network such as the Internet, or data broadcasting.
(5) This disclosure may be embodied as the vehicle position estimation method described above. It may also be embodied as a computer program for causing a computer to implement the above method, or as a digital signal including the program. Moreover, this disclosure may be realized as a non-transitory computer-readable recording medium, such as a CD-ROM, on which the program is recorded.
(6) This disclosure may also be embodied as a computer system including a microprocessor and a memory, in which the memory stores the above program and the microprocessor operates in accordance with the program.
(7) By recording the program or digital signal on a recording medium or transmitting the program or digital signal over a network, the disclosure may be implemented by another independent computer system.

### (Note)

The following technologies are disclosed in accordance with the foregoing description.
(Technology 1) A vehicle position estimation method for estimating the position of a ego-vehicle using a convolutional neural network, the method being executed by a computer and including: a first learning step of training the convolutional neural network using, as input data to the convolutional neural network, a training observation image including road-surface information and a training map image including a map of a region corresponding to the training observation image; a second learning step of training the convolutional neural network using, as input data, a processed image obtained by processing the training observation image and the training map image; an observation-image acquisition step of acquiring an observation image including road-surface information around the ego-vehicle; a map-image acquisition step of acquiring a map image including a map of a region corresponding to the observation image; and an estimation step of estimating the position of the ego-vehicle using the convolutional neural network trained by the first and second learning steps; wherein, in the processed image, the road-surface information contained in the training observation image has been processed.
(Technology 2) The vehicle position estimation method according to Technology 1, wherein noise is added to the road-surface information in the processed image.
(Technology 3) The vehicle position estimation method according to Technology 1 or 2, wherein the training observation image includes an image of road markings as road-surface information, and in the processed image at least a portion of the road-marking image is deleted.
(Technology 4) The vehicle position estimation method according to Technology 3, wherein the road-marking image includes a lane-marking image, the processed image includes a noise region that extends along the lane-marking image and simulates a region other than the road-marking image within the road-surface image, and at least a portion of the lane-marking image is deleted by the noise region.
(Technology 5) The vehicle position estimation method according to any one of Technologies 1 to 4, wherein the teacher data for the output data in the second learning step of the convolutional neural network is identical to the teacher data for the output data in the first learning step.
(Technology 6) The vehicle position estimation method according to any one of Technologies 1 to 5, wherein the convolutional neural network includes a skip-connection mechanism.
(Technology 7) The vehicle position estimation method according to any one of Technologies 1 to 6, wherein the teacher data for the output data of the convolutional neural network corresponds to a correlation distribution between the training observation image and the training map image, and in each of the first and second learning steps, a loss function representing the error between the output data and the corresponding teacher data is used, and weighting is performed in the loss function based on correlation values of the correlation distribution.
(Technology 8) A driving control method including the vehicle position estimation method according to any one of Technologies 1 to 7 and a driving control step of controlling travel of the ego-vehicle based on the position of the ego-vehicle estimated by the vehicle position estimation method.
(Technology 9) A program for causing a computer to execute the vehicle position estimation method according to any one of Technologies 1 to 7 or the driving control method of Technology 8.
(Technology 10) A vehicle position estimation device for estimating the position of a ego-vehicle using a convolutional neural network, the device including: an observation-image acquisition unit that acquires an observation image including road-surface information around the ego-vehicle; a map-image acquisition unit that acquires a map image including a map of a region corresponding to the observation image; and an estimation unit that estimates the position of the ego-vehicle using the observation image and the map image together with a trained convolutional neural network; wherein the convolutional neural network has been trained using, as input data to the convolutional neural network, a training observation image including road-surface information and a training map image including a map of a region corresponding to the training observation image, and has also been trained using, as input data, a processed image obtained by processing the training observation image and the training map image; and wherein, in the processed image, the road-surface information contained in the training observation image has been processed.
(Technology 11) A mobile object equipped with the vehicle position estimation device according to Technology 10 and a driving control unit that controls travel of the ego-vehicle based on the position of the ego-vehicle estimated by the vehicle position estimation device.

### Industrial Applicability

The vehicle position estimation method and the like according to one aspect of the present invention can be applied, for example, to vehicles for autonomous driving.

### EXPLANATION OF REFERENCE NUMERALS

10 Observation Unit
20 Observation-Image Acquisition Unit
30 Map-Image Acquisition Unit
40 Estimation Unit
40M Convolutional Neural Network
41 First Convolutional Layer
42 Second Convolutional Layer
43 Fully Connected Layer
44 Upsampling Layer
45 Skip-Connection Mechanism
50 Driving Control Unit
60 Storage Unit
100 Vehicle Position Estimation Device
DI Lane Marking
R1 Noise Region
V10 Mobile Object

1. A vehicle position estimation method for estimating a position of an ego-vehicle using a machine learning model, the method being executed by a computing system of the vehicle, the method comprising:
acquiring an observation image including information on a road surface around the ego-vehicle;
estimating the position of the ego-vehicle by processing, using a machine learning model, the observation image and a map image that comprises a map of a region corresponding to the observation image.

2. The method of claim 1, wherein the machine learning model was trained via training data that comprises artificially distorted observation images.

3. The vehicle position estimation method according to claim 2, wherein the artificially degraded observation images comprise artificially added noise.

4. The vehicle position estimation method according to claim 2 or 3, wherein at least one of the artificially degraded observation images was generated by deleting at least a portion of road-markings.

5. The vehicle position estimation method according to claim 4, wherein the road-markings comprise lane-markings, and at least one of the artificially degraded observation images includes a noise region that extends along the lane-markings, and at least a portion of the lane-marking image is deleted by the noise region.

6. The vehicle position estimation method according to any of claim 2 or 3, wherein the machine learning model was trained via a first learning step of training the machine learning model using a training observation image that comprises road-surface information and a training map image that comprises a map of a region corresponding to the training observation image; and
a second learning step of training the machine learning using the artificially distorted observation image.

7. The vehicle position estimation method according to claim 6, wherein teacher data for output data of the machine learning model corresponds to a correlation distribution between the training observation image and the training map image, and in each of the first and second learning steps a loss function representing an error between the output data and corresponding teacher data is used, and weighting is performed in the loss function based on correlation values of the correlation distribution.

8. The vehicle position estimation method according to claim 6, wherein teacher data for output data in the second learning step is identical to teacher data for output data in the first learning step.

9. The vehicle position estimation method according to any of claims 1-3, wherein the machine learning model comprises a convolutional neural network (CNN).

10. The vehicle position estimation method according to claim 8, wherein the CNN includes a skip-connection mechanism.

11. A driving control method comprising:
estimating a position of the vehicle via the vehicle position estimation method according to any of claims 1-3; and
a driving control step of controlling travel of the vehicle based on the estimated position of the vehicle.

12. A non-transitory computer-readable recording medium for use in a computer, the recording medium having a computer program recorded thereon for causing the computer to execute the vehicle position estimation method according to any of claims 1-3.

13. A vehicle position estimation system for estimating a position of an ego-vehicle, the system comprising one or more processors and memory storing one or more programs for execution by the one or more processors, wherein the one or more programs include instructions that when executed by the one or more processors cause the system to:
acquire an observation image including information on a road surface around the ego-vehicle; and
estimate the position of the ego-vehicle by processing, using a machine learning model, the observation image and a map image that comprises a map of a region corresponding to the observation image.

14. The system of claim 13, wherein the machine learning model was trained via training data that comprises artificially distorted observation images.

15. The system of claim 14, wherein the artificially degraded observation images comprise artificially added noise.

16. The system of claim 14 or 15, wherein at least one of the artificially degraded observation images was generated by deleting at least a portion of road-markings.

17. The system of claim 16, wherein the road-markings comprise lane-markings, and at least one of the artificially degraded observation images includes a noise region that extends along the lane-markings, and at least a portion of the lane-marking image is deleted by the noise region.

18. The system of any of claims 13-15, wherein the machine learning model was trained via a first learning step of training the machine learning model using a training observation image that comprises road-surface information and a training map image that comprises a map of a region corresponding to the training observation image; and
a second learning step of training the machine learning using the artificially distorted observation image.

19. The system of claim 18, wherein teacher data for output data in the second learning step is identical to teacher data for output data in the first learning step.

20. The system of claim 18, wherein teacher data for output data of the machine learning model corresponds to a correlation distribution between the training observation image and the training map image, and in each of the first and second learning steps a loss function representing an error between the output data and corresponding teacher data is used, and weighting is performed in the loss function based on correlation values of the correlation distribution.

21. The system of claim 14 or 15, wherein the machine learning model comprises a convolutional neural network (CNN).

22. The system of claim 21, wherein the CNN includes a skip-connection mechanism.

23. A vehicle comprising the vehicle position estimation system according to claim 14 or 15 and a driving control unit configured to control travel of the host vehicle based on the position of the host vehicle estimated by the vehicle position estimation device.
